(19) United States
(12) Patent Application Publication
(10) Pub. No.: US 2002/0175816 A1
(43) Pub. Date: Nov. 28, 2002

(54) Case giving warning by voice when taking out or replacing domestic lighter

(76) Inventor: Masayasu Nagabayashi, Tokyo (JP)

Correspondence Address: Stanley R. Moore, Esq., Jenkens and Gilchrist, P.C., 3200 Fountain Place, 1445 Ross Ave., Dallas, TX, 75202, US

(21) Appl. No.: 10/146,429

(22) Filed: May 14, 2002

(30) Foreign Application Priority Data
May 23, 2001 (JP) 2001-3245

(51) Int. Cl. G08B 13/14

(52) U.S. Cl. 340/568.1; 340/568.7

(57) ABSTRACT

An apparatus for messaging a warning to a user without fail upon handling of a domestic lighter for igniting a combustible gas issuing from a gas range includes a holder case having a lighter receiving/holding cavity formed therein for receiving a domestic lighter. An electric circuit including a voice reproducing switch and a speaker are installed in the holder case. The taking out of the domestic lighter from a domestic lighter receiving and holding cavity formed in the case for use and replacement thereof in that cavity are discretely detected by detecting means to generate a vocal sound by a voice reproducing switch array. On the basis of result of the detection, a corresponding voice message is generated from the speaker.

### BACKGROUND OF THE INVENTION

1. Field of the Invention

The present invention relates to a holder case for a rod-like lighter which is used for lighting or igniting a combustion gas ejected from a gas range or the like. More particularly, the invention is concerned with a combination of a holder case and a rod-like lighter which is improved in respect to the handling safety.

2. Description of the Related Art

Heretofore, such a lighter apparatus is known in which a gas cylinder and a sparking device such as constituted by a piezoelectric element or the like are disposed within a housing in such arrangement that a combustible gas is ejected from a gas ejection nozzle by manipulating a lighting manipulation lever and the ejected gas is lighted or ignited by a spark generated by the sparking device.

### SUMMARY OF THE INVENTION

Since the lighter apparatus of the type mentioned above is designed for handling the fire, it is required to arouse user's attention to the handling of the apparatus upon lighting as well as confirmation of extinction after the use. In this conjunction, it is however noted that in most of the hitherto known apparatuses, a method of affixing a paper sheet or the like in which the alarm or warning information is printed is adopted. Such written or printed information is however very poor in attracting user's attention.

In the light of the state of the art described above, it is an object of the present invention to provide a holder case for a lighter (or a combination of a lighter and a holder case therefor, to say in another way) which is capable of conveying warning information to the user to thereby arouse user's attention in handing the lighter without fail.

In view of the above and other objects which will become apparent as the description proceeds, there is provided according to a general aspect of the present invention a lighter/holder case for removably receiving a lighter. The case includes a lighter receiving/holding recess or cavity for removably receiving and holding or retaining therein a lighter. The holder case is implemented in such a structure in which when a user takes out the lighter from the holder case, a voice message for arousing user's attention in handling the lighter is generated while when the user places again the lighter in the holder case after the use, a voice prompting the user to confirm the safety after the use is generated.

### BRIEF DESCRIPTION OF THE DRAWINGS

FIG. 1A shows the lighter in a state being taken out from the holder case;

FIG. 1B shows the lighter in a state in which the lighter is being used;

FIG. 1C shows the lighter in a state being replaced in the holder case;

FIG. 2A shows a front view of the holder case;

FIG. 2B shows a side view of the holder case;

FIG. 3 shows an internal structure of the holder case;

FIG. 4A shows a state of the switch in which the rod-like lighter has been taken out from the holder case;

FIG. 4B shows a state in which the lighter is replaced within the holder case;

FIG. 5 shows an exemplary structure of an electric circuit employed in the apparatus according to an embodiment of the present invention;

FIG. 6A shows the switch in a state in which the lighter is replaced within the holder case;

FIG. 6B shows the switch in a state in which the lighter is taken out from the holder case;

FIG. 6C shows the state of the switch in which the lighter has been taken out from the holder case;

### DESCRIPTION OF THE EMBODIMENTS

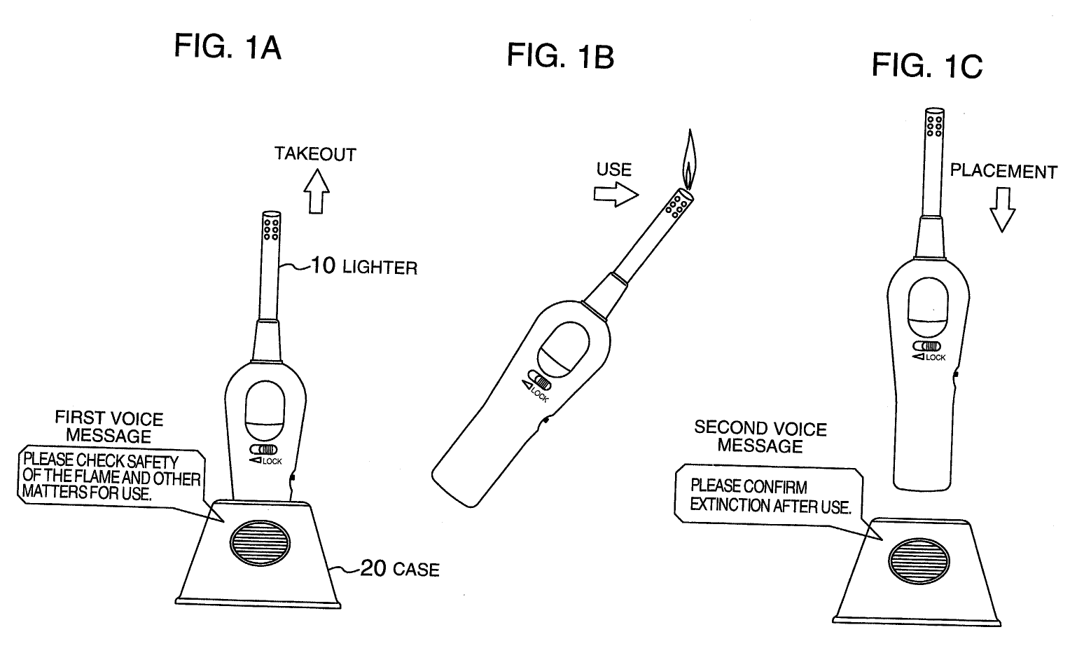

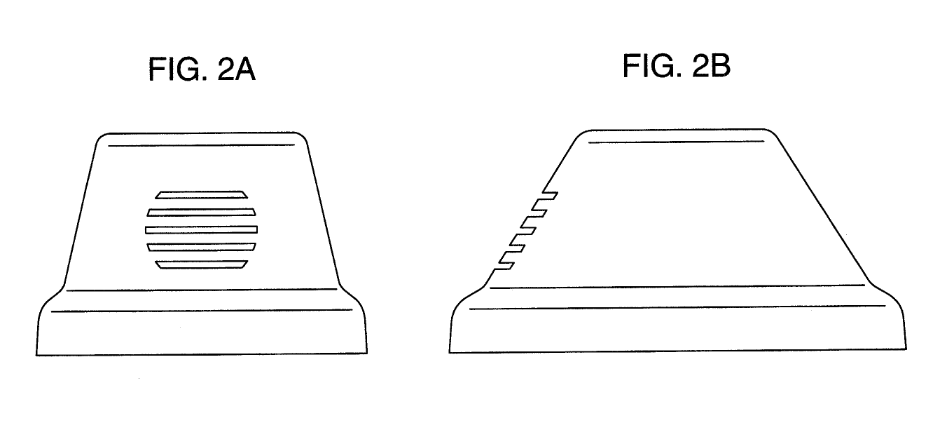

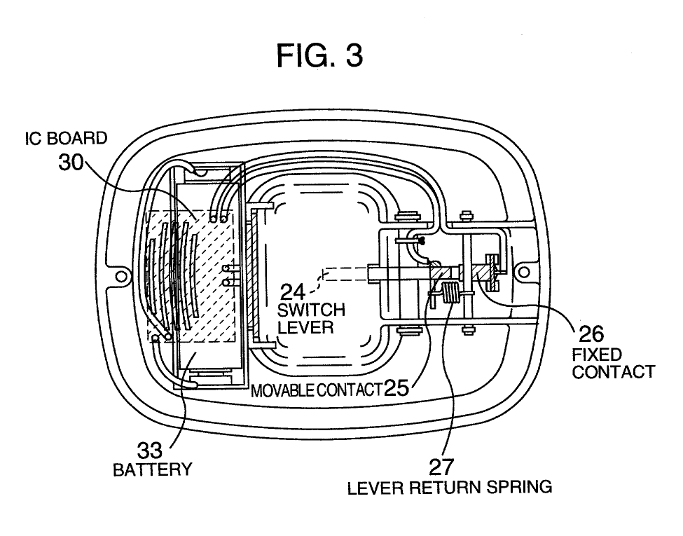

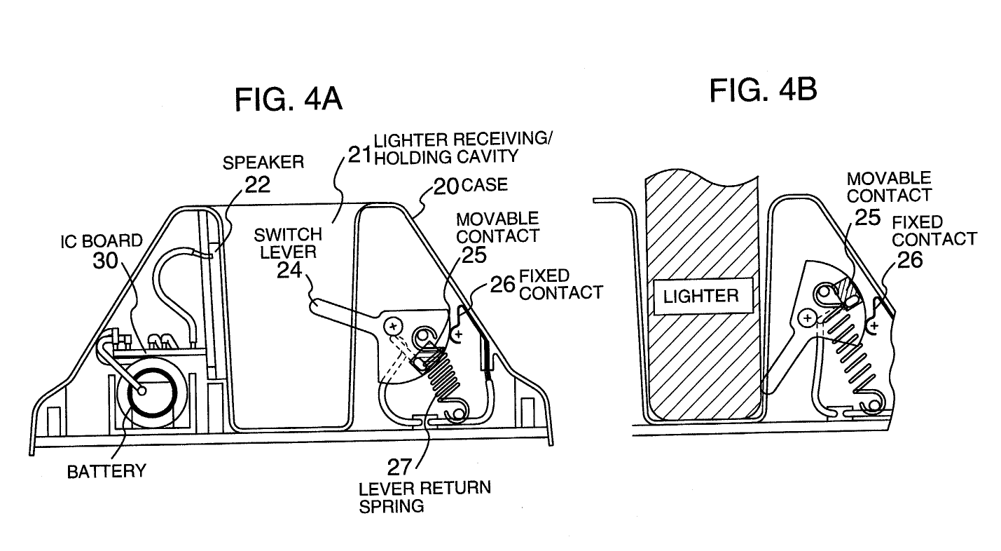

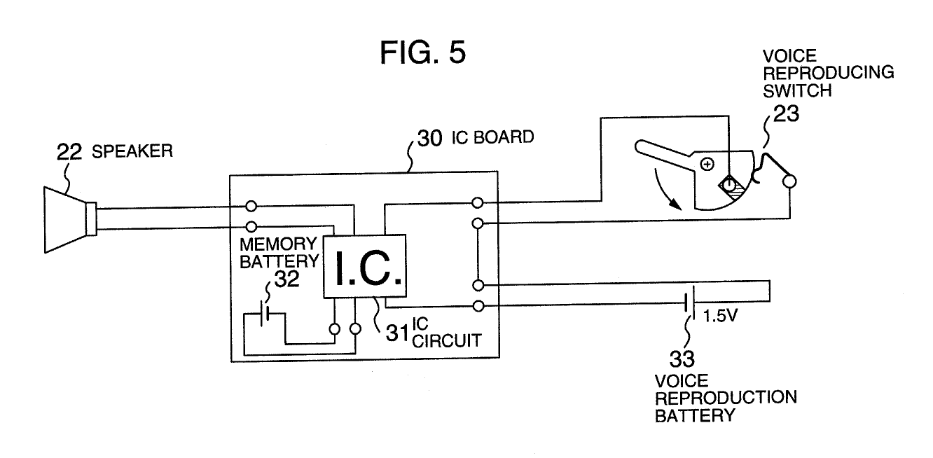

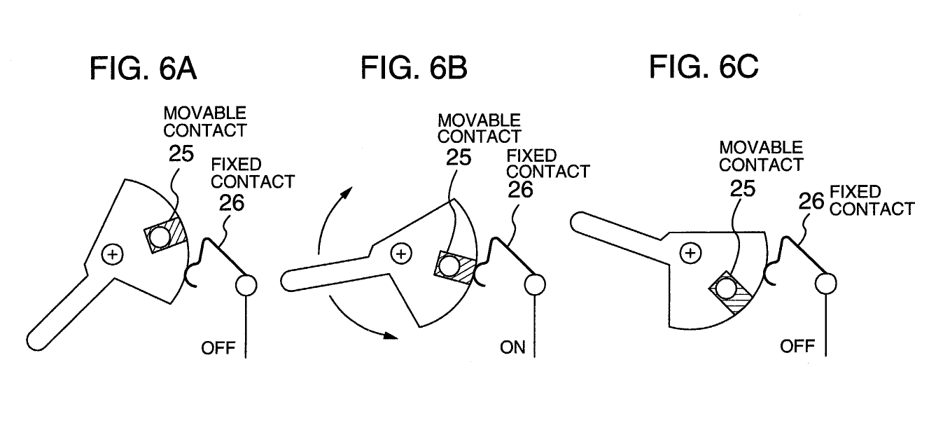

The present invention will be described in detail in conjunction with what is presently considered as preferred or typical embodiments thereof by reference to the drawings. FIGS. 1A to 1C are pictorial views for illustrating positional relationships between a rod-like lighter and a holder case, wherein FIG. 1A shows the lighter in the state ready for being taken out from the holder case, FIG. 1B shows a state in which the lighter is being used and FIG. 1C shows the lighter in the state replaced within the holder case. FIGS. 2A and 2B are views showing schematically outer appearance of the holder case, wherein FIG. 2A is a front view of the holder case and FIG. 2B is a side view of the same. FIGS. 3, 4A and 4B show an internal structure of the holder case, wherein FIG. 4A shows a state in which the rod-like lighter has been taken out from the holder case and FIG. 4B shows a state in which the lighter has been received within the holder case. FIG. 5 is a view showing an exemplary structure of an electric circuit employed in an apparatus according to an embodiment of the present invention. FIGS. 6A to 6C are views showing states of a voice reproducing switch employed in the electric circuit shown in FIG. 5, wherein FIG. 6A shows a state of the switch when the lighter is replaced within the holder case, FIG. 6B shows the state in which the rod-like lighter is being taken out from or replaced into the holder case, and FIG. 6C shows the state of the voice reproducing switch in which the rod-like lighter has been taken out from the holder case.

In the apparatus to which the present invention is directed, a rod-like lighter 10 is ordinarily disposed within a lighter receiving/holding cavity 21 formed in a holder case 20 (see FIGS. 1 and 4). An electric circuit including a speaker 22 is incorporated in the holder case 20. When a user takes out the lighter 10 from the holder case 20 for lighting or igniting a combustible gas ejected from e.g. a gas range or the like equipment, this is detected by the electric circuit incorporated in the holder case 20, whereby an attention arousing voice message (i.e., warning) such as “Please check safety of the flame and other matters for use.” is announced through the speaker 22. On the other hand, when the user replaces the lighter 10 back into the holder case 20 after the use, as is shown in FIG. 1C, the electric circuit incorporated in the holder case 20 detects insertion and disposition of the lighter 10 within the lighter receiving/holding cavity 21 formed in the holder case 20. In that case, a voice message such as “Please confirm extinction after the use.” is announced.

Now referring to FIGS. 3 and 4, description will be made of an embodiment of the present invention. In the holder case 20 according to the invention, there is formed the lighter receiving/holding cavity 21. The electric circuit mentioned above is mounted within an internal space of the holder case 20, as shown in FIG. 3. As can be seen in the figure, the electric circuit includes a voice reproducing switch 23 which is constituted by a switch lever 24, a movable contact 25, a fixed contact 26 and a lever return spring 27. It should be noted that the switch lever 24 is disposed in such state that the switch lever 24 can project into the lighter receiving/holding cavity 21 from a slit formed in a side wall of the lighter receiving/holding cavity 21.

More specifically, positional or operational relation between the switch lever 24 and the rod-like lighter 10 is illustrated in FIGS. 4A and FIG. 4B, wherein FIG. 4A shows a state in which the rod-like lighter 10 is not housed within the lighter receiving/holding cavity 21. In this state, the switch lever 24 assumes a position pushed up under the action of the lever return spring 27. On the other hand, in the state where the rod-like lighter 10 is disposed within the receptacle recess 21, the switch lever 24 is pushed downwardly by the lighter 10 to be thereby retracted from the inner space of the lighter receiving/holding cavity 21.

The electric circuit is implemented in such an arrangement as shown in FIG. 5. As can be seen in the figure, the electric circuit is comprised of an IC circuit 31, a memory battery 32 for sustaining information stored in a memory which is incorporated in the IC circuit 31, the speaker 22, the voice reproducing switch 23 and a battery 33 serving as a power source for the voice reproduction (this battery will also be referred to as the voice reproduction battery). Parenthetically, the IC circuit and others are mounted on an IC board 30 which in turn is installed internally of the holder case 20.

The IC circuit 31 shown in FIG. 5 incorporates a storage or memory for storing voice data and a voice synthesizing module. On the basis of the voice data stored in the memory, voice is synthesized by means of the voice synthesizing module to be outputted from the speaker 22. In a typical example, two sorts of voice data may be stored in the voice data storage or memory, e.g. first voice data corresponding to a voice message “Please check safety of the flame and other matters for use.” and second voice data corresponding to a voice message “Please confirm extinction after use.”. Additionally, the IC circuit includes a circuitry designed for storing the current status to thereby determine the voice message to be next outputted. These status data are held in the memory by the memory battery 32. Further, the voice message determining circuit is so designed as to detect closing of (i.e., contact between) the movable contact 25 and the fixed contact 26 of the voice reproducing switch 23 to thereby output alternately the first voice message and the second voice message upon every closing of the movable contact 25 and the fixed contact 26.

Relation between the motion or operation of the switch lever 24 of the voice reproducing switch 23 on one hand and the movable contact 25 and the fixed contact 26 on the other hand is illustrated in FIGS. 6A and 6B. More specifically, FIG. 6A shows the relation between the movable contact 25 and the fixed contact 26 in the state where the rod-like lighter 10 is housed within the lighter receiving/holding cavity 21 (the state shown in FIG. 4B). In this state, both the movable contact 25 and the fixed contact 26 are opened. When the rod-like lighter 10 is extracted from the lighter receiving/holding cavity 21, starting from this state, the switch lever 24 is caused to rotate clockwise under the action of the lever return spring 27. When the switch lever 24 reaches the position shown in FIG. 6B, the movable contact 25 is put into contact with the fixed contact 26 (i.e., the contacts 25 and 26 are closed). Shown in FIG. 6C is the state where the rod-like lighter 10 has been completely taken out from the receiving/holding cavity 21 (corresponding to the state shown in FIG. 4A). In this state, the movable contact 25 and the fixed contact 26 are again opened.

When the user replaces the rod-like lighter 10 in the holder case 20 after use, the switch lever 24 is forcibly pushed down by the lighter 10. As a result of this, the rod-like lighter 10 resumes the state shown in FIG. 6A, starting from the state shown in FIG. 6C via the state shown in FIG. 6B. In that case, the movable contact 25 and the fixed contact 26 are again closed when the state shown in FIG. 6B is reached.

In the state where the rod-like lighter 10 has been replaced within the receiving/holding cavity 21 of the holder case 20, as shown in FIG. 6A, a state storage circuit incorporated in the IC circuit stores therein information indicating a first state. When the user pulls out the rod-like lighter 10 from the lighter receiving/holding cavity 21, the voice reproducing switch 23 is caused to rotate to the position shown in FIG. 6B where the movable contact 25 and the fixed contact 26 are brought into contact with each other. When the IC circuit detects this state, the voice message “Please check safety of the flame and other matters for use.” is generated through the speaker by the voice synthesizing module on the basis of the first voice data in accordance with the information stored in the state storage circuit, i.e., the above-mentioned information indicating the first state. The IC circuit then changes the contents of the data stored in the state storage circuit to the information indicating a second state.

When the user replaces back the lighter 10 into the holder case 20, the switch lever 24 is pushed downwardly by the rod-like lighter 10. Thus, the switch lever 24 resumes the state shown in FIG. 6A from the state shown in FIG. 6C after passing the state shown in FIG. 6B. At that time, the movable contact 25 and the fixed contact 26 are again brought into contact in the state shown in FIG. 6B. When the IC circuit detects this state, the voice message “Please confirm extinction after use.” is generated through the speaker by the voice synthesizing module on the basis of the second voice data in accordance with the information stored in the state storage circuit, i.e., the above-mentioned information indicating the second state. The IC circuit then changes the contents stored in the state storage circuit to the information indicating the second state. Thus, the electric circuit is in the state waiting for the next use of the rod-like lighter.

As can now be understood from the foregoing description, with the apparatus according to the present invention, the warning information corresponding or appropriate to the prevailing state can be messaged in voice to the user, attracting his or her attention without fail when he or she takes out the lighter 10 from the holder case 20 or vice versa.

Many features and advantages of the present invention are apparent from the above description. However, since numerous modifications and combinations will readily occur to those skilled in the art, it is not intended to limit the invention to the construction and operation illustrated and described.

By way of example, in the case of the embodiment of the invention described above, detection of takeout of the rod-like lighter 10 is performed by means of the single contact provided in the voice reproducing switch. However, it is equally conceivable to adopt such arrangement that a plurality of contacts are provided for making decision as to whether the lighter 10 is taken out or replaced in dependence on the changing states of the plural contacts or alternatively the voice reproducing switch may be implemented in the form of a push-button switch disposed in a side wall or bottom wall of the lighter receiving/holding cavity 21 to thereby make decision as to takeout or replacement of the lighter 10 on the basis of the change of a contact of the push-button switch from the on-state to off-state or from the off-state to the on-state.

Further, the voice reproducing switch may be constituted by an optical switch or a magnetic switch in place of the mechanical switch. In that case, adverse influence of dust or the like can be avoided and hence the durability of the switch can be improved. Additionally, there is no need for providing two batteries, one for the memory and the other for the voice reproduction, but a single battery may be used for holding the information in the memory and reproducing the voice message.

Accordingly, all suitable modifications and equivalents may be resorted to, falling within the spirit and scope of the invention.

What is claimed is:

1. A lighter holder case for removably receiving a lighter, comprising:
a lighter housing portion for receiving and holding said lighter;
detecting means for discretely detecting takeout and replacement of said lighter from and in said lighter housing portion; and
memory means for storing at least two sorts of voice information,
wherein the taking out of said lighter from said lighter housing portion and replacement of said lighter in said lighter housing portion are detected by said detecting means to thereby generate a voice message from said voice information on the basis of the result of said detection.

2. A lighter holder case according to claim 1,
wherein said detecting means is provided in a side wall of said lighter housing portion.

3. A lighter holder case according to claim 1,
wherein said detecting means is provided at a bottom of said lighter housing portion.

4. A lighter holder case according to claim 1,
wherein said detecting means is constituted by a mechanical switch.

5. A lighter holder case according to claim 1,
wherein said detecting means is constituted by an optical detecting switch.

6. A lighter holder case according to claim 1,
wherein said detecting means is constituted by a magnetic detecting switch.
